(19) United States
(12) Patent Application Publication
(10) Pub. No.: US 2007/0013643 A1
(43) Pub. Date: Jan. 18, 2007

(54) Liquid crystal display and driving method therefor

(75) Inventors: Sunkwang Hong, Seongnam-si (KR); Tae-Sung Kim, Suwon-si (KR); Jae-Hyoung Park, Yongin-si (KR); Byung-Hyuk Shin, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/489,296

(22) Filed: Jul. 18, 2006

(30) Foreign Application Priority Data
Jul. 18, 2005 (KR) 10-2005-0064781

(51) Int. Cl. G09G 3/36

(52) U.S. Cl. 345/100

(57) ABSTRACT

A liquid crystal display in which differrent normal image data voltages obtained from one image are applied to the sub-pixel electrodes and an impulse data voltage is applied to one of the sub-pixel electrodes thereby avoiding a decrease in luminance as well as reducing blurring and flickering.

### CROSS-REFERENCE TO RELATED APPLICATION

This application claims priority to and the benefit of Korean Patent Application No. 10-2005-0064781 filed in the Korean Intellectual Property Office on Jul. 18, 2005, the entire contents of which are incorporated herein by reference.

### FIELD OF THE INVENTION

The present description relates to a liquid crystal display and a driving method thereof.

### DESCRIPTION OF THE RELATED ART

Liquid crystal displays (LCDs) are one of the most widely used flat panel displays. An LCD includes a pair of panels provided with field-generating electrodes such as pixel electrodes and a common electrode and a liquid crystal (LC) layer interposed between two panels. The LCD displays images by applying voltages to the field-generating electrodes to generate an electric field in the LC layer that determines the orientations of LC molecules therein to adjust polarization of incident light.

Among LCDs, the vertical alignment (VA) LCD, which aligns LC molecules such that the long axes of the LC molecules are perpendicular to the panels in the absence of an electric field, has been spotlighted because of its high contrast ratio and wide reference viewing angle which is defined as the angle at which the contrast ratio is 1:10 or as the limit angle for the inversion in luminance between grays. The wide viewing angle of the VA mode LCD can be realized by making cutouts and protrusions in the field-generating electrodes which can determine the tilt directions of the LC molecules. The tilt directions can be distributed in several directions by disposing the cutouts and protrusions in various ways, such that the reference viewing angle is widened. However, the VA mode LCD has relatively poor lateral visibility compared with front visibility.

For example, a patterned VA (PVA) mode LCD having the cutouts shows an image that becomes bright as it goes far from the front, and in the worse case, the luminance difference between high grays vanishes such that the images cannot be perceived. In order to improve the lateral visibility, it has been suggested to divide each of the pixel electrodes into two sub-pixel electrodes that are capacitively coupled to each other. Then, a voltage is applied directly to one sub-pixel and the other sub-pixel is supplied with a lower voltage due to the capacitive coupling. The different sub-pixel voltages causes the two sub-pixels to have different transmittances. On the other hand, since an LCD tends to hold a displayed image, the edges of figures moving images may be blurred and lack sharpness.

In order to prevent blurring, an impulse driving method that inserts a black image for a short time between normal images has been developed. However, since black images are displayed in the impulse driving method, the overall brightness is reduced and flickering may occur to cause the screen to flicker at the boundary between a black image and a normal image.

### SUMMARY OF THE INVENTION

The present invention prevents the blurring of an image, minimizes the luminance decrease and flickering improves lateral visibility by applying different first and second normal image data voltages obtained from one image to the first and second sub-pixel electrodes while the impulse data voltage is applied to any one of the first and second sub-pixel electrodes. Further, the first normal image data voltage may advantageously be greater than the second normal image data voltage, and the area of the first sub-pixel electrode may be smaller than the area of the second sub-pixel electrode. The impulse data voltage may advantgeously be any one among the lowest gray voltage, a black gray voltage, and a gray voltage for luminance in a predetermined range.

The method of driving a liquid crystal display includes converting M bundles of image information received into respective M bundles of first and second normal image data and generating a bundle of impulse data; and converting the first and second normal image data and the impulse data into the first and second normal image data voltages and the impulse data voltage, respectively (where M is a natural number). The application of the first and second normal image data voltages includes: generating first and second sets of gray voltages that are different from each other; and selecting the first and second normal image data voltages from the first and second sets of gray voltages. The application of the first and second normal image data voltages includes the step of applying the first and second normal image data voltages for the first M rows of pixels to the first and second sub-pixel electrodes in the first M rows of pixels alternately and sequentially, respectively, and the application of the impulse data voltage includes the step of applying the impulse data voltage to the second sub-pixel electrodes in the second M rows of pixels at the same time (where M is a natural number).

### BRIEF DESCRIPTION OF THE DRAWING

The foregoing and other objects and features of the invention may become more apparent from a reading of the ensuing description together with the drawing, in which:

FIG. 1 is a block diagram of an LCD according to an embodiment of the present invention;

FIG. 2 is an equivalent circuit diagram of a pixel of an LCD;

FIG. 3 is a timing diagram illustrating driving signals of an LCD;

FIG. 4 is a schematic diagram illustrating images displayed according to the driving signals illustrated in FIG. 3 during one frame.

FIG. 5 is a block diagrame of the data driver;

FIG. 6 is a crcuit diagram of the charge sharing unit shown in FIG. 5.

FIG. 7 shows waveforms of a voltage following one data line in accordance with a load signal, a gate clock sigal, and a reverse signal in charge sharing.

FIG. 8 is an equivalent circuit diagram of two sub-pixels of an LCD according to another embodiment of the present invention;

FIG. 9 is an equivalent circuit diagram of a pixel of an LCD

FIG. 10 is a timing diagram illustrating driving signals of an LCD including the pixel illustrated in FIG. 6;

FIG. 11 is a schematic diagram illustrating images displayed according to the driving signals illustrated in FIG. 10 during one frame.

FIG. 12 and FIG. 13 are timing diagrams illustrating other examples of driving signals of an LCD according to other embodiments of the present invention;

FIG. 14 is an equivalent circuit diagram of a pixel of an LCD according to another embodiment of the present invention;

FIG. 15 is a timing diagram illustrating driving signals of an LCD including the pixel illustrated in FIG. 14;

FIG. 16 is an equivalent circuit diagram of a pixel of an LCD according to another embodiment of the present invention; and

FIG. 17 is a timing diagram illustrating driving signals of an LCD including the pixel illustrated in FIG. 16.

### DETAILED DESCRIPTION OF THE EMBODIMENTS

To clarify multiple layers and regions, the thicknesses of the layers are enlarged in the drawings. Like reference numerals designate like elements throughout the specification. When it is said that any part, such as a layer, film, area, or plate, is positioned on another part, it means the part is directly on the other part or above the other part with at least one intermediate part. On the other hand, if any part is said to be positioned directly on another part it means that there is no intermediate part between the two parts.

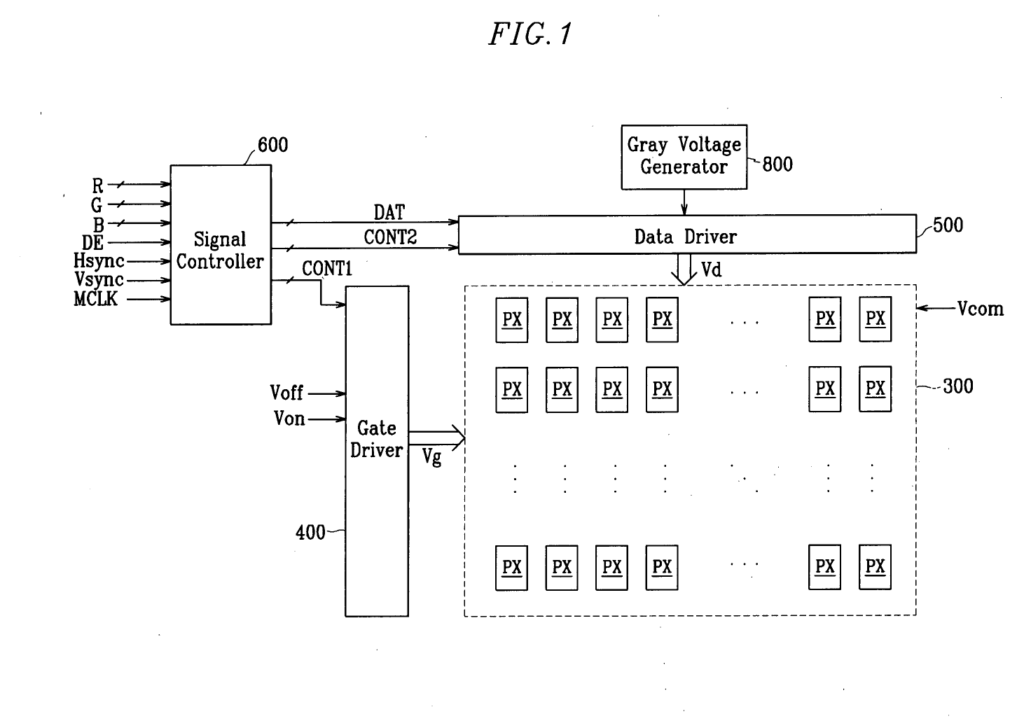

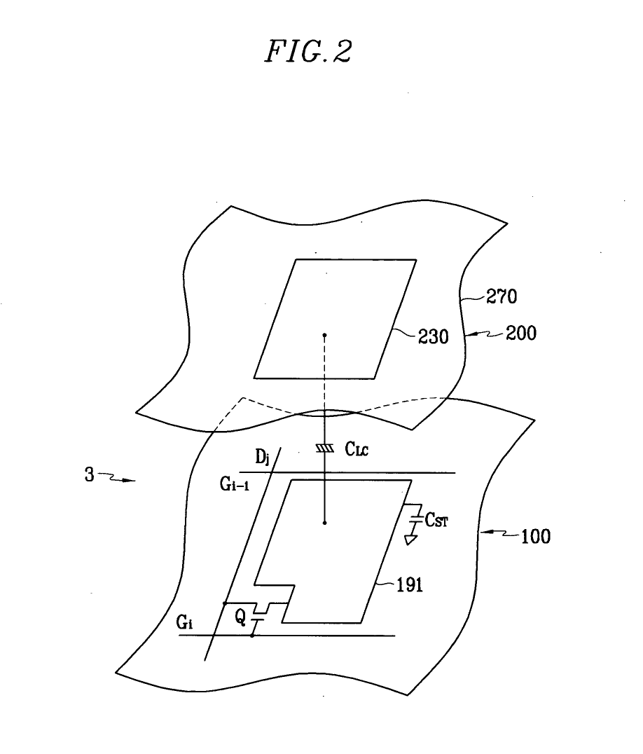

First, an LCD according to an embodiment of the present invention will be described in detail with reference to FIG. 1 and FIG. 2. FIG. 1 is a block diagram of an LCD according to an embodiment of the present invention, and FIG. 2 is an equivalent circuit diagram of a pixel of an LCD according to the embodiment of the present invention. As shown in FIG. 1, an LCD according to an embodiment of the present invention includes a liquid crystal panel assembly 300, a gate driver 400 and a data driver 500 that are connected to the liquid crystal panel assembly 300, a gray voltage generator 800 connected to data driver 500, and a signal controller 600 controlling the above elements.

Liquid crystal panel assembly 300 includes a plurality of signal lines Gᵢ and Dⱼ (i=1, 2, . . . , n, j=1, 2, . . . , m), and a plurality of pixels PX connected thereto and arranged substantially in a matrix, as seen in the equivalent circuit diagram. Assembly 300 includes lower and upper panels 100 and 200 that face each other and an LC layer 3 interposed therebetween, in a structural view shown in FIG. 2.

Display signal lines Gᵢ and Dⱼ include a plurality of gate lines Gᵢ for transmitting gate signals (also referred to as “scanning signals”) and a plurality of data lines Dⱼ for transmitting data signals. Gatelines Gᵢ extend substantially in a row direction and substantially parallel to each other, and data lines Dⱼ extend substantially in a column direction and substantially parallel to each other.

Each pixel PX includes a switching element Q connected to signal lines Gᵢ and Dⱼ, and an LC capacitor C_{LC} and a storage capacitor CST that are connected to the switching element Q. If unnecessary, the storage capacitor CST may be omitted.

Switching element Q, including a thin film transistor (TFT), is a three-terminal element provided on the lower panel 100 and it has a control terminal connected to gateline Gᵢ, an input terminal connected to data line Dⱼ, and an output terminal connected to the LC capacitor C_{LC} and the storage capacitor C_{ST}.

Liquid crystal capacitor C_{LC} includes a pixel electrode 191 provided on the lower panel 100 and a common electrode 270 provided on the upper panel 200 as two terminals, and the LC layer 3 disposed between the two electrodes 191 and 270 functions as a dielectric of the LC capacitor C_{LC}.

Pixel electrode 191 is connected to the switching element Q, and the common electrode 270 is formed on the entire surface of the upper panel 200 and supplied with a common voltage Vcom.

Unlike FIG. 2, the common electrode 270 may be provided on the lower panel 100, and in this case, at least one of the two electrodes 191 and 270 may have the shape of a bar or a stripe.

Storage capacitor C_{ST}, functioning as an auxiliary capacitor for the LC capacitor C_{LC}, is formed by overlapping a separate signal line (not shown) that is provided on the lower panel 100 with pixel electrode 191 via an insulator disposed therebetween, and the separate signal line is supplied with a predetermined voltage such as a common voltage Vcom. Alternatively, the storage capacitor C_{ST} may be formed by overlapping pixel electrode 191 with an upper previous gate line via an insulator.

In order to implement color display, each pixel PX uniquely displays one of the primary colors (spatial division) or each pixel PX sequentially displays the primary colors in turn (temporal division) such that the spatial or temporal sum of the primary colors is recognized as a desired color. The primary colors are red, green, and blue.

FIG. 2 shows an example of spatial division in which each pixel PX includes a color filter 230 representing one of the primary colors in an area of the upper panel 200 facing pixel electrode 191. Unlike FIG. 2, the color filter 230 may be provided on or under pixel electrode 191 provided on the lower panel 100. One or more polarizers (not shown) for polarizing light are attached on the outer surface of the liquid crystal panel assembly 300.

Referring to FIG. 1 again, the gray voltage generator 800 generates two sets of a plurality of gray voltages (or reference gray voltages) related to the transmittance of pixels PZ+X. The two sets of (reference) gray voltages are generated based on different gamma curves from each other. The (reference) gray voltages in one set have a positive polarity with respect to the common voltage Vcom, while those in the other set have a negative polarity with respect to the common voltage Vcom. However, only one set of (reference) gray voltages may be generated instead of generating the two sets of (reference) gray voltages.

Gate driver 400 is connected to gatelines Gᵢ of the liquid crystal panel assembly 300 and synthesizes a gate-on voltage Von and a gate-off voltage Voff to generate gate signals Vg that are applied to gatelines Gᵢ.

Data driver 500 is connected to data lines Dⱼ of the liquid crystal panel assembly 300 and selects one set out of the two sets of gray voltages supplied from the gray voltage generator 800 and then applies a gray voltage among the selected set of gray voltages to data line Dⱼ as a data signal. However, in the case where the gray voltage generator 800 supplies only reference gray voltages of predetermined number rather than supplying voltages for all grays, data driver 500 divides the reference gray voltages to generate gray voltages for all grays, from which data signals are selected.

Signal controller 600 controls gate driver 400 and data driver 500. Each of the drivers 400, 500, 600, and 800 mentioned above may be directly mounted on the liquid crystal panel assembly 300 in the form of at least one integrated circuit (IC) chip, or may be mounted on a flexible printed circuit film (not shown) in a tape carrier package (TCP) type that is attached to the liquid crystal panel assembly 300, or may be mounted on a separate printed circuit board (not shown). On the other hand, each of the drivers 400, 500, 600, and 800 may be integrated into the liquid crystal panel assembly 300 in the form of a plurality of driving circuits. Also, the drivers 400, 500, 600, and 800 may be integrated into a single chip, and in this case, at least one thereof or at least one circuit element forming those may be located outside of the single chip.

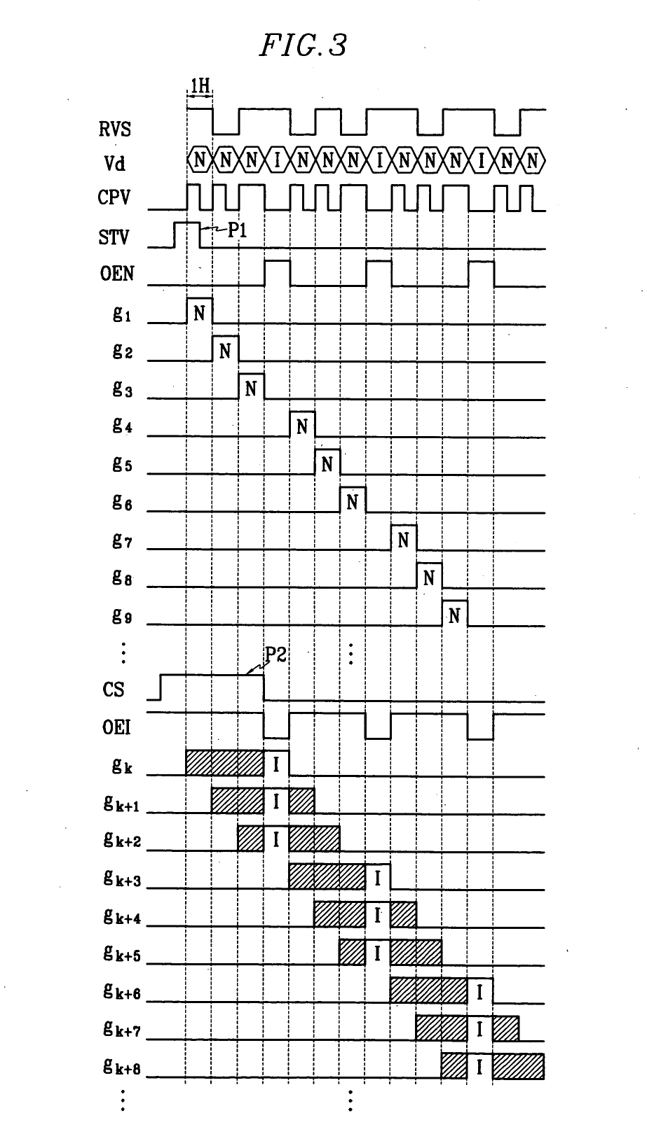

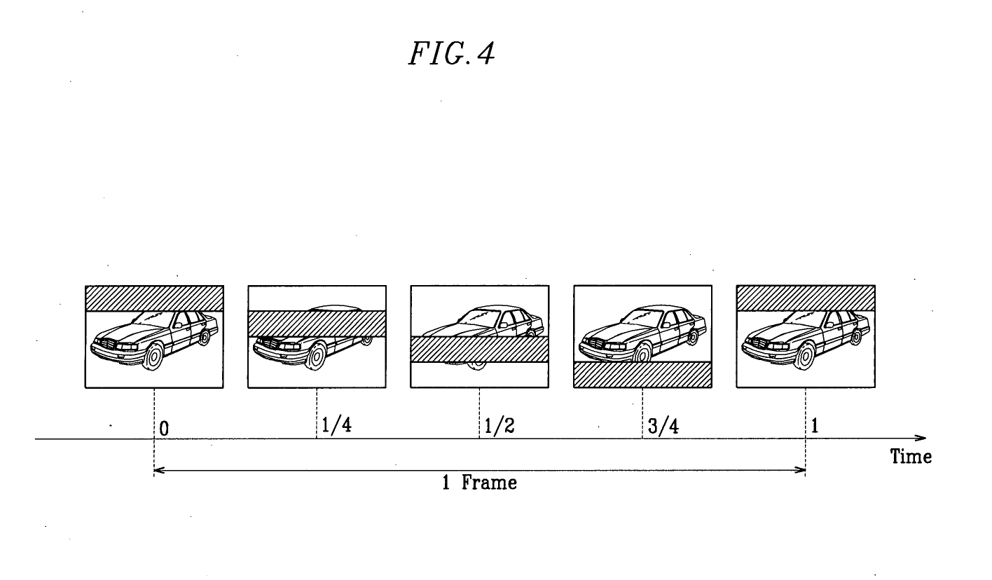

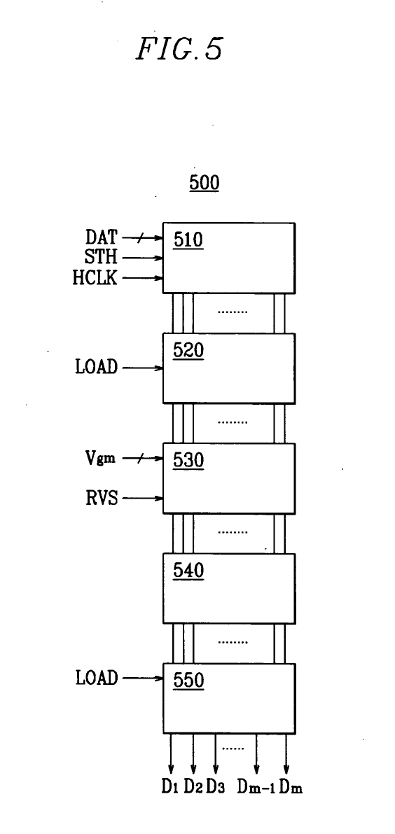

The operation of the above-described LCD will be described in detail with reference to FIG. 3 and FIG. 5. FIG. 3 is a timing diagram illustrating driving signals of an LCD according to an embodiment of the present invention, and FIG. 4 is a schematic diagram illustrating images displayed according to the driving signals illustrated in FIG. 3 during one frame.

Signal controller 600 is supplied with input image signals R, G, and B and input control signals controlling the display thereof from an external graphics controller (not shown). The input image signals R, G, and B include luminance information of each pixel PX, and the luminance has a predetermined number of grays, for example, 1024 (=2¹⁰), 256 (=2⁸), or 64 (=2⁶) grays. The input control signals include, for example, a vertical synchronization signal Vsync, a horizontal synchronization signal Hsync, a main clock MCLK, and a data enable signal DE.

On the basis of the input control signals and the input image signals R, G and B, signal controller 600 adequately processes the input image signals R, G, and B suitably for the operating condition of the liquid crystal panel assembly 300 and data driver 500 and generates gate control signals CONT1 and data control signals CONT2. Then, signal controller 600 transmits gate control signals CONT1 to gate driver 400 and transmits the processed image signals DAT and data control signals CONT2 to data driver 500.

Output image signals DAT are digital signals having a predetermined number of values (or grays) and include normal image data generated based on the input image signals R, G, and B and impulse data for impulse driving.

Gate control signals CONT1 include a scanning start signal STV for instructing to start scanning, a gate clock signal CPV for controlling the output time of a gate-on voltage Von, and at least one output enable signal OE for defining the duration of the gate-on voltage Von.

Data control signals CONT2 include a horizontal synchronization start signal STH for informing of the start of output image signals DAT transmission for a row of pixels PX, a load signal LOAD for instructing to apply data signals to the liquid crystal panel assembly 300, and a data clock signal HCLK.

Data control signal CONT2 further includes an inversion signal RVS for reversing the voltage polarity of the data signals with respect to the common voltage Vcom (hereinafter, “the voltage polarity of the data signals with respect to the common voltage Vcom” is referred to as “the polarity of the data signals”).

Signal controller 600 converts M bundles of input image signals R, G, and B into M bundles of normal image data and generates a bundle of impulse data, and then it transmits (M+1) bundles of output image signals DAT during the substantially same time while the M bundles of input image signals R, G, and B are inputted (where M is a natural number).

Therefore, the frequency of the horizontal synchronization start signal STH is (M+1)/M times the frequency of the horizontal synchronization signal Hsync. Also, the frequency of data clock signal HCLK with which the output image signals DAT are synchronized may be (M+1)/M times the frequency of the main clock MCLK with which the input image signals R, G, and B are synchronized. For example, M is set as 3 in FIG. 3.

In response to data control signals CONT2 from signal controller 600, data driver 500 receives output image signals DAT for a row of pixels PX, converts the output image signals DAT into analog data voltages Vd by selecting gray voltages corresponding to the respective output image signals DAT, and applies the analog data voltages to the corresponding data lines Dⱼ.

Data voltages Vd include normal image data voltages N into which the normal image data are converted and an impulse data voltage I into which the impulse data is converted. Data driver 500 operates a charge sharing function in synchronization with the load signal LOAD before the applicaiotn of the data voltages to data lines Dⱼ. The charge sharing function will be described in detail later.

When the gray voltage generator 800 generates two sets of gray voltages, gray values of the normal image data are the same as those of the impulse data, and gray voltages for the respective grays of the normal image data and the impulse data may be different from each other since different sets of gray voltages correspond to the normal image data and the impulse data, respectively.

The gamma curve of the normal image data is determined according to the characteristics of an LCD, and the gamma curve of the impulse data represents lower luminance than the gamma curve of the normal image data. In some cases, the gamma curve of the impulse data may represent black for all grays or an arbitrary fixed luminance.

On the contrary, when the gray voltage generator 800 generates one set of gray voltages, impulse data may be generated by compensating the input image signals R, G, and B in accordance with a predetermined rule.

The impulse data have gray values smaller than the gray values of the normal image data for the same input image signals R, G, and B, and in some cases, the impulse data may have an arbitrary fixed gray. The fixed gray may be the lowest gray, black, or a gray at a predetermined level representing luminance in a predetermined range.

Gate driver 400 applies a gate on voltage Von to at least one gate line Gᵢ in response to gate control signals CONT1 from signal controller 600, thereby turning on the switching element Q connected to gateline Gᵢ. Then, data voltage Vd applied to data line Dⱼ is applied to the corresponding pixel PX through the turned-on switching element Q. The difference between the data voltage applied to the pixel PX and the common voltage Vcom is represented as a charge voltage, which is referred to as a pixel voltage.

The LC molecules have orientations depending on the magnitude of the pixel voltage, and the molecular orientations determine the polarization of light passing through the LC layer 3. This change of the light polarization causes a change of the light transmittance through the polarizers attached to the liquid crystal panel assembly 300.

By repeating this procedure by a unit of the horizontal period (which is also denoted by “1H”), all pixels PX are sequentially supplied with normal image data voltages N and an impulse data voltage I, and normal images and impulse images for a frame are displayed once during one frame.

When one frame is finished, the next frame starts, and the inversion signal RVS applied to data driver 500 is controlled such that the polarity of data voltage Vd applied to the respective pixels PX is reversed to be opposite to the polarity in the previous frame (which is referred to as “frame inversion”). Here, even in one frame, polarity of the normal image data voltages N flowing in a data line may vary in accordance with the characteristics of the inversion signal RVS (for example, row inversion and dot inversion). Otherwise, polarities of the normal image data voltages N applied to a packet of pixels may be different from each other (for example, column inversion and dot inversion).

The polarity of the impulse data voltage I also varies in accordance with the characteristics of the inversion signal RVS, but it may have an arbitrary polarity unlike FIG. 3. The normal images are sequentially displayed one by one pixel from the first row of pixels to the bottom row, and the impulse images are sequentially displayed three by three pixels from the k-th row of pixels to the bottom row. By displaying like this, an impulse image band having a width of the k-th row looks like it rotates. When necessary, the normal images and the impulse images may be displayed starting from the bottom row to the top row. This will be described in more detail as follows.

The scanning start signal STV including a normal image data pulse P1 for normal image data and an impulse data pulse (not shown) for impulse data is applied to the gate driving circuit (or integrated circuit chip) that is connected to the gate line in the first row of pixels. The normal image data pulse P1 has a width of 1H, and the impulse data pulse has a width of 4H.

The time when the impulse data pulse is generated is determined on the basis of the position where the impulse images are displayed. If the impulse data voltage I is applied to pixels PZ+X in the k-th through the (k+2)-th rows of pixels after normal image data voltages N are applied to pixels PZ+X in the first through the third rows of pixels, an impulse data pulse is generated at the time when a (n−k)/n vertical period elapses after the normal image data pulse is generated (where n is the vertical resolution).

One normal image data pulse P1 and one impulse data pulse are generated in one frame. Carry signals CS generated by the previous gate driving circuit also include a normal image data pulse (not shown) for normal image data and an impulse data pulse P2 for impulse data and is applied to the respective gate driving circuits except for the gate driving circuit that the scanning start signal STV is applied to.

Due to the impulse data pulse of the scanning start signal STV, the impulse data pulse P2 of the carry signal CS is applied to the gate driving circuit connected to the gate line in the k-th row of pixels when the normal image data pulse P1 of the scanning start signal STV is applied to the first gate driving circuit. A plurality of output enable signals OE that limit the duration of a gate-on voltage Von that is supplied to and output from the respective gate driving circuits have two waveforms including a normal image data waveform OEN for normal image data and an impulse data waveform OEI for impulse data, which alternate at appropriate times under the control of signal controller 600.

These two waveforms OEN and OEB are reversed to form each other and have a period equal to four horizontal periods. A high level of the output enable signals OE represses the output of the gate-on voltage Von to make the gate-off voltage Voff be output, while a low level thereof make the gate-on voltage Von be output. Therefore, when the output enable signals OE have a normal image data waveform OEN, only the normal image data voltages N are applied to the corresponding pixels PX since a gate-on voltage Von is output during the application of the normal image data voltages N.

On the contrary, when the output enable signals OE have an impulse data waveform OEI, only the impulse data voltage I is applied to the corresponding pixels PX since a gate-on voltage Von is output during the application of the impulse data voltage I. The output enable signal OE applied to a gate driving circuit to which the normal image data pulse P1 of the scanning start signal STV and the carry signal CS is applied has a normal image data waveform OEN, while the output enable signal OE applied to a gate driving circuit, which the impulse data pulse P2 of the scanning start signal STV and the carry signal CS is applied to, has an impulse data waveform OEI.

A gate clock signal CPV includes a first clock having a width of 1H and a second clock having a width of 2H, and two of the first clocks and one of the second clock alternate repeatedly. Each scanning pulse is generated in synchronization with each clock rising edge of the gate clock signal CPV. Therefore, no scanning pulse is generated at every fourth starting point of the horizontal period when the second clock of gate clock signal CPV falls.

The width of the scanning pulse is substantially equal to the width of the pulses P1 and P2 of the scanning start signal STV and the carry signal CS.

When the pulse P1 of the scanning start signal STV is applied to the first gate driving circuit, the respective scanning pulses are sequentially applied to the corresponding gate lines as gate signals g1, g2, and g3 in the first to third horizontal periods. Then, the output from the first gate driving circuit is repressed due to the output enable signal OE in the fourth horizontal period. Again, the respective scanning pulses are sequentially applied to the corresponding gate lines as gate signals g4, g5, and g6 in the fifth to seventh horizontal periods, and the output from the gate driving circuit is repressed in the eighth horizontal period. In this way gate signals are applied to all the gate lines. Thereby, normal image data voltages N are sequentially applied from pixels PZ+X connected to the first gate line, and so the respective pixels PX are sequentially charged with their own normal image data voltages N.

When the pulse P2 of the carry signal CS is applied to the gate driving circuit connected to the gate line in the k-th row of pixels, and in response to this, each scanning pulse has a width of 4H and overlaps each other. However, the output from the gate driving circuit is repressed due to the output enable signal OE in the first to third horizontal periods (the repressed parts of the scanning pulse are shaded with oblique lines), but a gate-on voltage Von is output in the fourth horizontal period.

Therefore, gate signals gₖ, gₖ₊₁, and gₖ₊₂ are applied to the corresponding gate lines at the same time in the fourth horizontal period. Likewise, gate signals gₖ₊₃, gₖ₊₄, and gₖ₊₅ are applied to the corresponding gate lines at the same time in the eighth horizontal period. In this way, gate signals are applied to all gate lines to the last gate line, and again, gate signals are applied from the first gate line to the (k−1)-th gate line. Thereby, impulse data voltage I is applied to three pixels at one time, three by three from pixels PZ+X connected to the k-th gate line, so all pixels PX are sequentially charged with the impulse data voltage I.

Referring to FIG. 4, impulse images of the previous frame are displayed from the top to the ¼ position of the initial screen for one frame, and normal images of the previous frame are displayed below the ¼ position of the screen. For the driving signals in FIG. 3 k is equal to n/4, thus the vertical width of the impulse images is 25% of the vertical width of the whole screen. This ratio represents the ratio of the impulse images to all images displayed at one pixel during a frame.

When the pulse P1 of the scanning start signal STV and the pulse P2 of the carry signal CS are applied, normal images are sequentially displayed downwards from the top of the screen, and impulse images are sequentially displayed from the upper ¼ position of the screen to the bottom. After a ¼ frame elapses, normal images are displayed from the top to the upper ¼ position of the screen, and impulse images are displayed from the upper ¼ position to the middle of the screen.

As described above, impulse images are displayed erasing the normal images of the previous frame, and normal images are displayed erasing the upper part of the impulse images. The impulse images are displayed having a width of 25% of the screen and look as if they rotate from the top to the bottom during a frame.

In FIG. 3, the operation was described with respect to three rows of pixels, but it may be described with respect to an arbitrary number of rows of pixels. Also, k is a variable regulating the vertical width of the impulse image band and may be set as necessary within the range of the vertical resolution. By displaying normal images and impulse images as described above, blurring can be prevented and charge ratio of the pixel voltages can be increased since the increase of the frequency for impulse driving is relatively low.

Before the application of the normal image data voltage or the impulse data voltage to data lines D₁-Dₘ, data driver 500 operates the charge sharing in synchronization with the load signal LOAD, to connect data lines D₁-Dₘ to each other. The operation of data driver 500 will be described in detail with reference to FIG. 5.

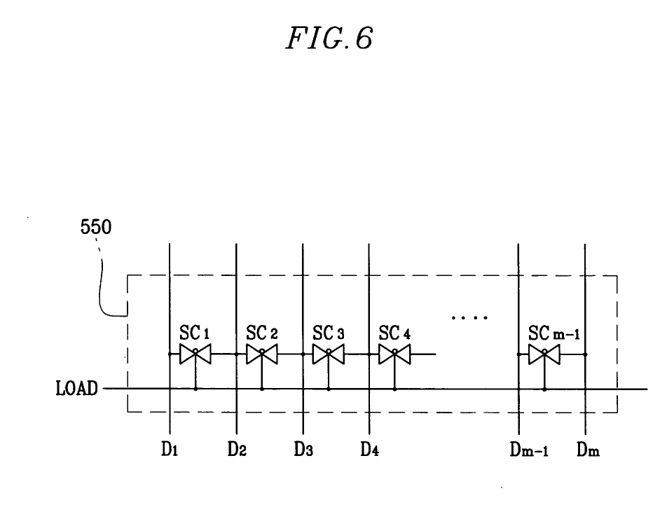

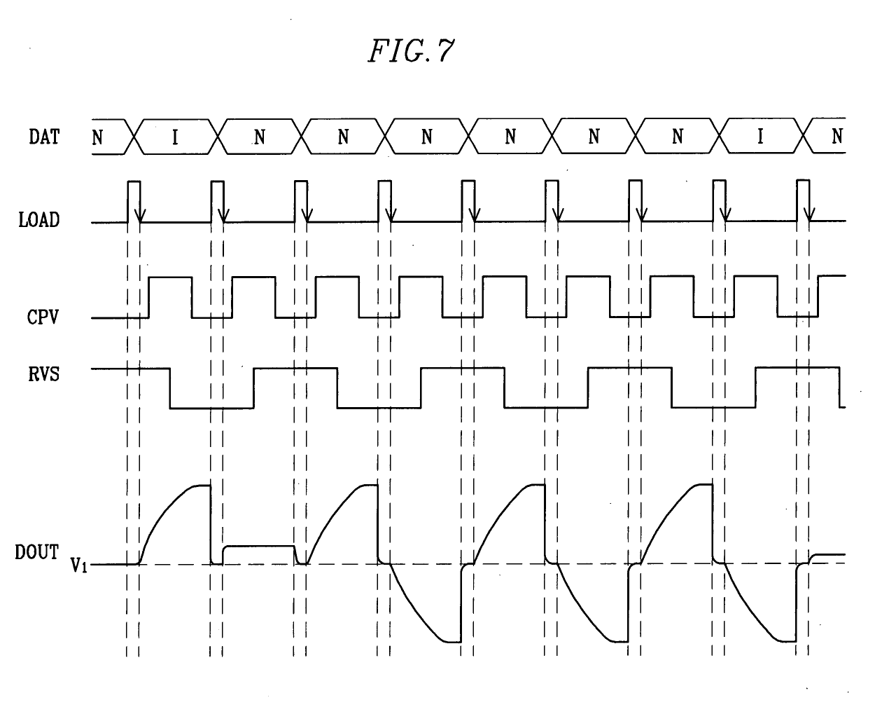

FIG. 5 is a block diagram of the data driver according to an embodiment of the present invention, FIG. 6 is a circuit diagram of the charge sharing unit shown in FIG. 5, and FIG. 7 shows waveforms of a voltage following one data line in accordance with a load signal, a gate clock signal, and a reverse signal in charge sharing.

Referring to FIG. 5, data driver 500 includes a shift register unit 510, a latch 520, a digital-analog converter 530, a buffer 540, and a charge sharing unit 550. As shown in FIG. 6, the charge sharing unit 550 includes a plurality of switching elements SC₁-SCₘ₋₁ connected between adjacent data lines. Each switching element SC₁-SCₘ₋₁ is a transmission gate having a control terminal and an inverse control terminal. The switching elements SC₁-SCₘ₋₁ are supplied with the load signal LOAD through the control terminals.

Shift register unit 510 is supplied with the horizontal synchronization start signal STH and transmits the image data DAT for a row of pixels PX to the latch 520 by sequentially shifting the input image data DAT in synchronization with data clock signal HCLK. Shift register unit 510 includes a plurality of shift registers. Each shift register stores the image data DAT by sequentially shifting it a predetermined amount, and then outputs a shift clock signal (not shown) to a shift register of the next stage. By repeating the procedure, the image data DAT for a row of pixels PX are sequentially shifted into the shift register unit 510.

Latch 520 outputs the image data DAT from the shift register unit 510 to the digital-analog converter 530 in synchronization with the load signal LOAD. Digital-analog converter 530 is supplied with the gray voltages V_{gm} from the gray voltage generator 800 and selects one of the gray voltages V_{gm}, which corresponds to the image data DAT, respectively. The polarity of the selected gray voltage is defined by the reverse signal RVS. Next, the digital-analog converter 530 converts the selected gray voltages into corresponding analog data voltages, respectively.

Buffer 540 outputs the analog data voltages from the digital-analog converter 530 to the charge sharing unit 550. As described above, the charge sharing unit 550 includes transmission gates supplied with the load signal LOAD through the control terminals. Referring to FIG. 7, for a high level of the load signal LOAD, the transmission gates SC₁-SCₘ₋₁ are turned-on, and thereby all data lines D₁-Dₘ are connected to each other. Thereby, voltage levels of all data lines D₁-Dₘ are the same as a predetermined level, that is, charge sharing is performed. Next, when a level of the load signal LOAD is changed into a low level, the transmission gates SC₁-SCₘ₋₁ are turned-off in synchronization with a falling edge of the load signal LOAD, and thereby the data voltages are transmitted through data lines D₁-Dₘ.

Accordingly, by the charge sharing based on the load signal LOAD, the voltages DOUT change the normal image data voltages or the impulse data voltages after the voltages DOUT have a predetermined magnitude V1. At this time, it is preferable that the load signal LOAD has a pulse width enough to reach the voltages DOUT at the predetermined magnitude V1 by the charge sharing. Preferably, the pulse width of the load signal LOAD may be about 1.0 μs and more. Furthermore, preferably, a period from a time that the load signal LOAD is changed from a low level to a high level to a time that gate clock signal CPV is changed from a low level to a high level may be about 1.8 μs.

At this time, the polarity of the data voltage is defined by a level of the reverse signal RVS when the image data for a row of pixels PX are applied from latch 520 to digital-analog converter 530 in synchronization with load signal LOAD changing from a low level to a high level. That is, when the level of the reverse signal RVS is high, the polarity of the data voltage is positive, and when the level of the reverse signal RVS is low the polarity of the data voltage is negative. However, the polarity relation of the data voltage and the reverse signal RVS may be reversed.

As described above, before applying the data voltages corresponding to the image data DAT to data lines D₁-Dₘ, the voltages of all data lines D₁-Dₘ are made uniform at the predetermined magnitude V1 by the charge sharing. Thereby, since voltages of data lines D₁-Dₘ vary from the uniform voltage V1 to a desired voltage, such as the normal image data voltage or the impulse data voltage, all pixels PZ+X are charged by the impulse data voltages or the normal image data voltages, under the same charging condition.

Thus, horizontal line deterioration decreases due to the difference between the charging condition when a pixel is charged from an impulse data voltage of one polarity, such as a black image data voltage, into a normal image data voltage and the charging condition when a pixel is charged from a normal image data voltage into a normal image data voltage of the opposite polarity.

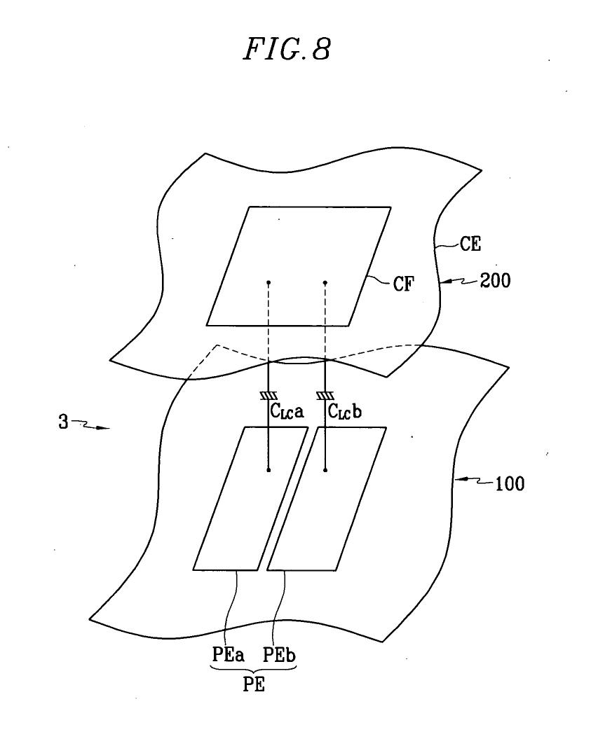

Next, an LCD according to another embodiment of the present invention will be described in detail with reference to FIG. 8 along with FIG. 1. However, detailed description will be omitted for the same parts as the previous embodiment described above. FIG. 8 is an equivalent circuit diagram of two sub-pixels of an LCD according to another embodiment of the present invention.

As shown in FIG. 1, an LCD according to another embodiment of the present invention also includes a liquid crystal panel assembly 300, a gate driver 400, a data driver 500, a gray voltage generator 800, and a signal controller 600. As shown in FIG. 8, the liquid crystal panel assembly 300 includes a plurality of display signal lines (not shown), and a plurality of pixels PX connected thereto and arranged substantially in a matrix, as seen in the equivalent circuit diagram.

Liquid crystal panel assembly 300 includes lower and upper panels 100 and 200 that face each other and an LC layer 3 interposed therebetween, as in the structural view shown in FIG. 8.

The display signal lines include a plurality of gate lines (not shown) for transmitting gate signals (also referred to as “scanning signals”) and a plurality of data lines (not shown) for transmitting data signals. The gate lines extend substantially in a row direction and substantially parallel to each other, and the data lines extend substantially in a column direction and substantially parallel to each other.

Each pixel PX includes a pair of sub-pixels, and each sub-pixel includes an LC capacitor C_{LC}a and C_{LC}b, respectively. At least one of the two sub-pixels includes a switching element (not shown) connected to a gate line, a data line, and an LC capacitor C_{LC}a and C_{LC}b. LC capacitor C_{LC}a/C_{LC}b includes a sub-pixel electrode PEa/PEb provided on the lower panel 100 and a common electrode CE provided on the upper panel 200 as two terminals, and LC layer 3 disposed between the sub-pixel electrode PEa/PEb and the common electrode CE functions as a dielectric of LC capacitor C_{LC}a/C_{LC}b.

The pair of sub-pixel electrodes PEa and PEb are separated from each other and form a pixel electrode PE. Common electrode CE is formed on the entire surface of the upper panel 200 and is supplied with a common voltage Vcom.

LC layer 3 has negative dielectric anisotropy, and the LC molecules in the LC layer 3 may be aligned such that their long axes are substantially horizontal or perpendicular to the two panels in the absence of an electric field. In order to implement color display, each pixel PX may display colors by the method of spatial division or temporal division.

FIG. 8 shows an example of spatial division in which each pixel PX includes a color filter CF representing one of the primary colors in an area of the upper panel 200 facing pixel electrode PE. Unlike FIG. 8, color filter CF may be provided on or under the first and second sub-pixel electrodes PEa and PEb provided on the lower panel 100.

Polarizers (not shown) are provided on the outer surface of the panels 100 and 200, and the polarization axes of the two polarizers may be perpendicular to each other. One of the two polarizers may be omitted when the LCD is a reflective LCD. When the polarization axes of the two polarizers are perpendicular to each other, incident light into the LC layer in the absence of an electric field cannot pass through the polarizer.

Gray voltage generator 800 generates at least two sets of a plurality of gray voltages (or reference gray voltages) related to transmittance of pixels PZ+X. At least two sets of (reference) gray voltages are generated on the basis of different gamma curves from each other. Each set of (reference) gray voltages includes voltages having positive-polarity with respect to the common voltage Vcom and voltages having negative-polarity with respect to the common voltage Vcom. However, only one set of (reference) gray voltages may be generated instead of generating at least two sets of (reference) gray voltages.

Now, the operation of the above-described LCD will be described in detail. Signal controller 600 is supplied with input image signals R, G, and B and input control signals controlling the display thereof from an external graphics controller. On the basis of the input control signals and the input image signals R, G and B, signal controller 600 adequately processes the input image signals R, G, and B suitably for the operating condition of the liquid crystal panel assembly 300 and data driver 500 and generates gate control signals CONT1 and data control signals CONT2. Then, signal controller 600 transmits gate control signals CONT1 to gate driver 400 and transmits the processed image signals DAT and data control signals CONT2 to data driver 500.

Output image signals DAT include normal image data generated based on the input image signals R, G, and B and impulse data for impulse driving. Gate control signals CONT1 include a scanning start signal STV, a gate clock signal CPV, and at least one output enable signal OE.

Data control signals CONT2 include a horizontal synchronization start signal STH for informing of the start of image data transmission for a packet of sub-pixels, a load signal LOAD for instructing to apply the data signals to the liquid crystal panel assembly 300, a data clock signal HCLK, and an inversion signal RVS.

In response to data control signals CONT2 from signal controller 600, data driver 500 receives output image signals DAT for a packet of sub-pixels, converts the output image signals DAT into analog data voltages Vd by selecting gray voltages corresponding to the respective output image signal DAT, and applies the analog data voltages to the corresponding data lines.

Gate driver 400 applies a gate on voltage Von to a gate line in response to gate control signals CONT1 from signal controller 600, thereby turning on the switching element connected to the gate line. Then, the data voltages applied to the data lines are applied to the corresponding sub-pixels PXa and PXb through the turned-on switching element.

When a pair of sub-pixel electrodes PEa and PEb forming a pixel electrode PE are connected to separate switching elements respectively, that is, each sub-pixel has its own respective switching element, the two sub-pixels may be applied with different data voltages either through the same data line at a different time from each other or through different data lines from each other at the same time.

On the other hand, when a sub-pixel electrode PEa is connected to a switching element (not shown) and the other sub-pixel electrode PEb is capacitively coupled to the sub-pixel electrode PEa, only the sub-pixel including the sub-pixel electrode PEa is supplied with data voltages through the switching element, and the sub-pixel including the sub-pixel electrode PEb is supplied with voltages depending on the voltages of the sub-pixel electrode PEa.

The area of a sub-pixel electrode PEa is smaller than the area of a sub-pixel electrode PEb, and the voltage of the sub-pixel electrode PEa is higher than the voltage of the sub-pixel electrode PEb.

Like this, when the potential difference is generated across the LC capacitors C_{LC}a and C_{LC}b, an electric field that is substantially perpendicular to the panels 100 and 200 is generated in the LC layer 3.

Hereinafter, pixel electrode PE and the common electrode CE are referred to together as “field generating electrodes”. Then, the LC molecules in the LC layer 3 tilt in response to the electric field such that their long axes become perpendicular to the electric field direction, and the degree of the tilt of the LC molecules determines the change of the polarization of incident light onto the LC layer 3. This change of the light polarization causes a change of light transmittance through the polarizers, and in this way, the LCD displays images.

The tilt angle of the LC molecules depends on the strength of the electric field. Since the voltages of the two LC capacitors C_{LC}a and C_{LC}b are different from each other, the tilt angles of the LC molecules are also different from each other and thus the luminance of the two sub-pixels are different. Accordingly, voltage of LC capacitor C_{LC}a and voltage of the LC capacitor C_{LC}b can be adjusted so that an image viewed from a lateral side is most similar to an image viewed from the front, that is, the lateral gamma curve can be made to be most similar to the frontal gamma curve, thereby improving the lateral visibility. Also, when the area of the sub-pixel electrode PEa applied with higher voltage is smaller than that of the sub-pixel electrode PEb, the lateral gamma curve can be more similar to the frontal gamma curve.

Particularly, when the area ratio of the sub-pixel electrodes PEa and PEb is approximately 1:2, the lateral gamma curve is much more similar to the frontal gamma curve, thereby more improving the lateral visibility. By repeating this procedure by a unit of the horizontal period (which is also denoted by “1H”), all sub-pixels PXa and PXb are sequentially supplied with data voltages Vd, and normal images and impulse images for a frame are displayed during one frame.

When one frame is finished, the next frame starts, and the inversion signal RVS applied to data driver 500 is controlled such that the polarity of data voltage Vd applied to the respective sub-pixels PXa and PXb is reversed to be opposite to the polarity in the previous frame. Even in one frame, the inversion signal RVS applied to data driver 500 is controlled in accordance with the polarity inversion type such as row inversion, dot inversion, and column inversion.

During one frame, normal images based on the normal image data are displayed in the sub-pixels PXa, and normal images based on the normal image data and impulse images based on the impulse data are displayed once for each in the sub-pixels PXb. Even though impulse images are displayed only in the sub-pixel PXb as mentioned above, if the area ratio of the sub-pixel electrode PEb to the sub-pixel electrode PEa is increased and the display ratio of the impulse images to the whole screen is increased, blurring can be reduced to the same level as when the impulse images are displayed in the sub-pixels PXa and PXb.

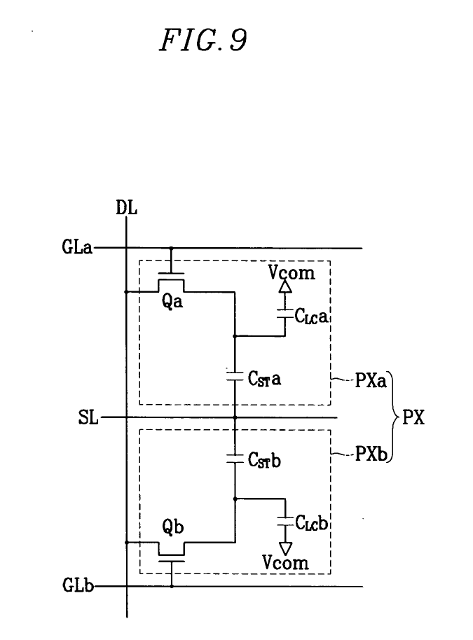

An LCD according to another embodiment of the present invention, wherein the two sub-pixels illustrated in FIG. 8 are applied with different data voltages through the same data line at a different time from each other, will be described in detail with reference to FIG. 9.

FIG. 9 is an equivalent circuit diagram of a pixel of an LCD according to another embodiment of the present invention. Referring to FIG. 9, an LCD according to another embodiment of the present invention has signal lines including a plurality of pairs of gate lines GLa and GLb, a plurality of data lines DL, and a plurality of storage electrode lines SL and a plurality of pixels PX connected to signal lines.

Each pixel PX includes a pair of sub-pixels PXa and PXb, and each sub-pixel PXa/PXb includes a switching element Qa/Qb that is connected to the corresponding gate line GLa/GLb and a data line DL respectively, an LC capacitor C_{LC}a/C_{LC}b that is connected to the switching element Qa/Qb, and a storage capacitor C_{ST}a/C_{ST}b that is connected to the switching element Qa/Qb and the storage electrode line SL.

Each switching element Qa/Qb, including a thin film transistor (TFT), is a three-terminal element provided on the lower panel 100, and it has a control terminal connected to a gate line GLa/GLb, an input terminal connected to a data line DL, and an output terminal connected to an LC capacitor C_{LC}a/C_{LC}b and a storage capacitor C_{ST}a/C_{ST}b.

Storage capacitor C_{ST}a/C_{ST}b functioning as an auxiliary capacitor for the LC capacitor C_{LC}a/C_{LC}b is formed by overlapping a storage electrode line SL that is provided on the lower panel 100 with a sub-pixel electrode PEa/PEb via an insulator disposed therebetween, and the storage electrode line SL is supplied with a predetermined voltage such as the common voltage Vcom.

Alternatively, the storage capacitors C_{ST}a and C_{ST}b may be formed by overlapping the sub-pixel electrodes PEa and PEb with an upper previous gate line via an insulator. Here, detailed description of the LC capacitors C_{LC}a and C_{LC}b, which were described above in the previous embodiment, will be omitted.

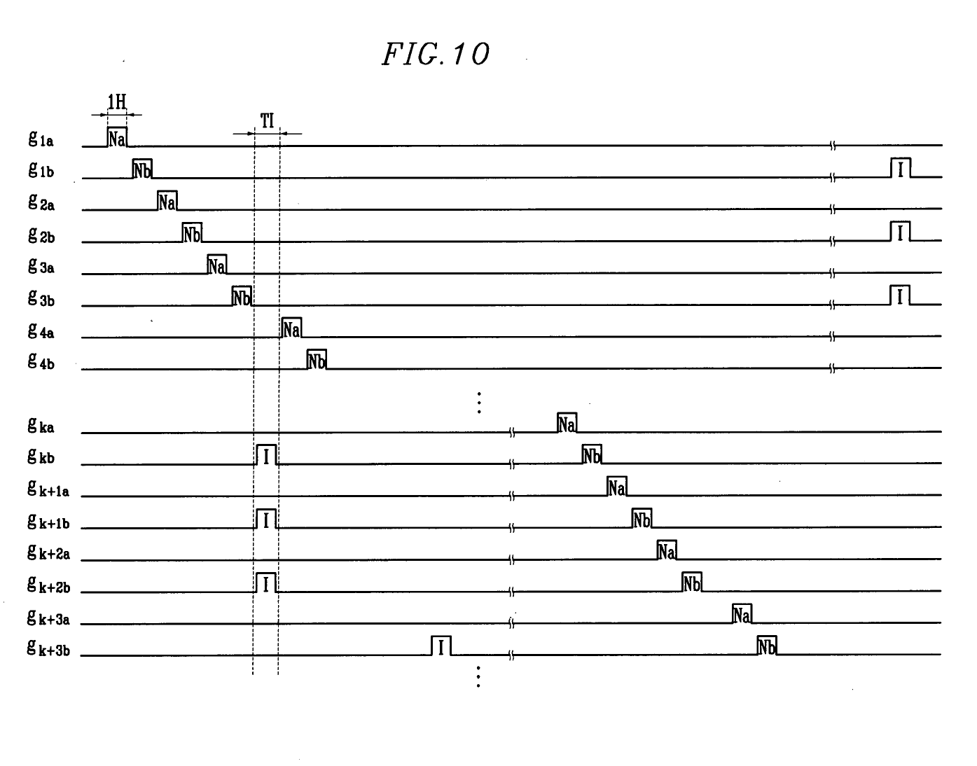

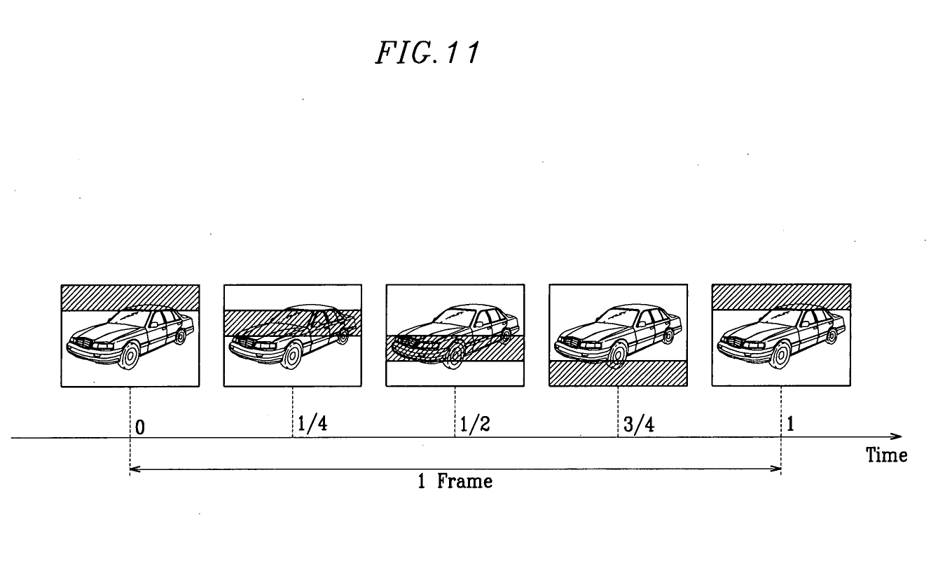

The operation of the above-described LCD will be described in detail with reference to FIG. 10 and FIG. 11. FIG. 10 is a timing diagram illustrating driving signals of an LCD including the pixel illustrated in FIG. 9, and FIG. 11 is a schematic diagram illustrating images displayed according to the driving signals illustrated in FIG. 10 during one frame.

In the LCD including the pixel illustrated in FIG. 9, signal controller 600 supplied with input image signals R, G, and B converts them into output image signals DAT including normal image data Na for the sub-pixels PXa, and normal image data Nb and impulse data I for the sub-pixels PXb, which are transmitted to data driver 500.

Signal controller 600 converts M bundles of input image signals R, G, and B into M bundles of normal image data Na and M bundles of normal image data Nb and generates a bundle of impulse data I, and then it transmits (2M+1) bundles of output image signals DAT during the substantially same time while the M bundles of input image signals R, G, and B are input (where M is a natural number).

Therefore, the frequency of the horizontal synchronization start signal STH is (2M+1)/M times the frequency of the horizontal synchronization signal Hsync. Also, the frequency of data clock signal HCLK with which the output image signals DAT are synchronized may be (2M+1)/M times the frequency of the main clock MCLK with which the input image signals R, G, and B are synchronized. For example, M is set as 3 in FIG. 10.

Data driver 500 receives output image signals DAT for a row of sub-pixels, converts the output image signals DAT into analog data voltages Vd by selecting gray voltages corresponding to the respective output image signals DAT, and applies the analog data voltages Vd to the corresponding data lines DL. When gray voltage generator 800 generates one set of gray voltages, the normal image data Na and Nb may be generated to be different from each other, thereby applying different voltages to respective sub-pixels PXa and PXb. Alternatively, separate sets of gray voltages for the two sub-pixels PXa and PXb, which are alternately applied to data driver 500 or alternately selected by data driver 500, may be generated while the normal image data are the same, thereby applying different voltages to the two sub-pixels PXa and PXb, respectively. However, it is preferable to compensate the image signals or generate sets of gray voltages such that the merged gamma curve of the two sub-pixels PXa and PXb is close to the frontal reference gamma curve.

For example, the frontal merged gamma curve is made to accord with the frontal reference gamma curve that is determined to be the most appropriate for the liquid crystal panel assembly, and the lateral merged gamma curve is made to be most similar to the frontal reference gamma curve.

With respect to the impulse data I, the gray voltage generator 800 may generate separate sets of gray voltages, or the sets of gray voltages for the normal image data Na and Nb may be used.

As illustrated in FIG. 10, data driver 500 sequentially applies data voltages Vd for the respective sub-pixels PXa and PXb in the first through third rows of pixels to the corresponding data lines DL every 1H during the first through sixth horizontal periods.

Gate driver 400, which is synchronized with this, also sequentially applies gate signals g₁ₐ-g_{3b} to gatelines GLa and GLb respectively connected to the sub-pixels PXa and PXb in the first through third rows of pixels every 1H during the first through sixth periods, thereby turning on the switching elements Qa and Qb connected respectively to gatelines GLa and GLb.

Then, data voltages Vd applied to data lines DL, which correspond to the normal image data Na and Nb, are applied to the corresponding sub-pixels PXa and PXb through the turned-on switching elements Qa and Qb, respectively. Then, data driver 500 applies data voltages Vd for impulse data I to data lines DL during the seventh horizontal period TI.

In the seventh horizontal period TI, gate driver 400 applies gatesignals g_{kb}, g_{k+1b}, and g_{k+2b} to gatelines GLb connected to the sub-pixels PXb in the k-th through (k+2)-th rows of pixels respectively at the same time, thereby turning on the switching elements Qb connected to gatelines GLb.

Then, data voltages Vd applied to data lines DL and corresponding to the impulse data I are applied to the corresponding sub-pixels PXb through the turned-on switching elements Qb. In this way, data voltages Vd corresponding to the normal image data Na and Nb are applied to the corresponding sub-pixels PXa and PXb during 6 horizontal periods for every three rows of pixels, and data voltages Vd corresponding to the impulse data I are applied to the corresponding sub-pixels PXb during 1 horizontal period.

During one frame, data voltages Vd corresponding to the normal image data Na are applied to all sub-pixels PXa, and data voltages Vd corresponding to the normal image data Nb and the impulse data I are applied to all sub-pixels PXb once for each, thereby displaying normal images and impulse images for one frame.

The process of displaying the normal images and the impulse images is illustrated in FIG. 11. Like FIG. 4, k is equal to n/4 (n is the vertical resolution), and detailed description about the pattern displayed will be omitted here since it is substantially same as FIG. 4.

However, since normal images are displayed in the sub-pixels PXa located in the region where impulse images are displayed, like the portions shaded with oblique lines, luminance in this region is higher than the same region illustrated in FIG. 4. In the present embodiment, even though impulse images are displayed in the sub-pixels PXb, impulse images may be displayed in the sub-pixels PXa.

As mentioned above, luminance decrease can be minimized as well as blurring prevented by displaying impulse images in any one of the two sub-pixels PXa and PXb while normal images are displayed in the other sub-pixel. In addition, charge ratio of the pixel voltages can be increased, since the increase of the frequency for impulse driving is relatively low, by displaying impulse images in the sub-pixels in a plurality of rows at the same time.

Numerous characteristics of the LCD illustrated in FIG. 2 to FIG. 4 may be applied to the LCD illustrated in FIG. 8 to FIG. 11.

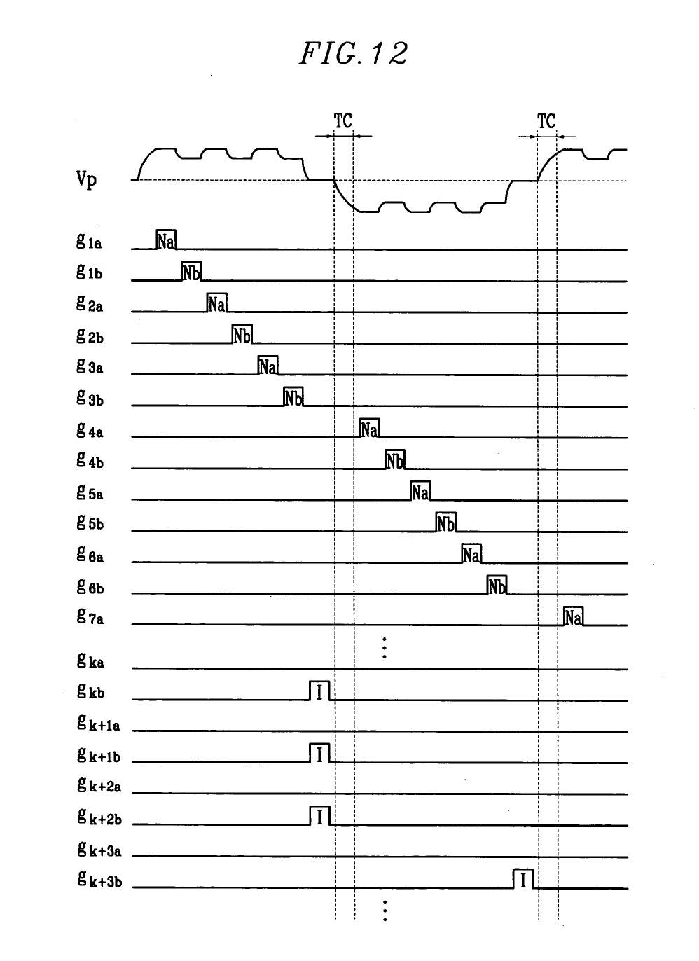

Next, another driving method for displaying impulse images in an LCD including the pixel illustrated in FIG. 9 will be described in detail with reference to FIG. 12. FIG. 12 is a timing diagram illustrating other examples of driving signals of an LCD according to other embodiments of the present invention. The timing diagram illustrated in FIG. 12 is about driving signals in which polarity of the data voltages is reversed every three rows of pixels. As illustrated in FIG. 12, data driver 500 sequentially applies data voltages having positive-polarity for the respective sub-pixels PXa and PXb in the first through third rows of pixels to the corresponding data lines DL every 1H during the first through sixth horizontal periods.

Gate driver 400, which is synchronized with this, also sequentially applies gate signals g₁ₐ-g_{3b} to gatelines GLa and GLb respectively connected to the sub-pixels PXa and PXb in the first through third rows of pixels every 1H during the first through sixth periods, thereby turning on the switching elements Qa and Qb connected to gatelines GLa and GLb respectively.

Data voltages Vd having positive-polarity applied to data lines DL, which correspond to normal image data Na and Nb, are applied to the corresponding sub-pixels PXa and PXb through the turned-on switching elements Qa and Qb, respectively. Data driver 500 applies data voltages Vd for impulse data I to data lines DL during the seventh horizontal period.

In the seventh horizontal period, gate driver 400 applies gatesignals g_{kb}, g_{k+1b}, and g_{k+2b} to gatelines GLb connected to the sub-pixels PXb in the k-th through the (k+2)-th rows of pixels respectively at the same time, thereby turning on the switching elements Qb connected to gatelines GLb.

Data voltages Vd applied to data lines DL and corresponding to the impulse data I are applied to the corresponding sub-pixels PXb through the turned-on switching elements Qb. Data driver 500 applies a predetermined data voltage having negative-polarity during a period of predetermined time TC. However, no gate line is applied with a gate-on voltage Von. The predetermined time TC may be equal to or different from 1 horizontal period.

Also, the predetermined data voltage having negative-polarity may be determined on the basis of the data voltages having negative-polarity for normal image data Na applied to the sub-pixels PXa in the fourth row of pixels, but it may have a fixed value.

In this way, data voltages Vd corresponding to the normal image data Na and Nb are applied to the corresponding sub-pixels PXa and PXb during 6 horizontal periods for every three rows of pixels, and data voltages Vd corresponding to the impulse data I are applied to the corresponding sub-pixels PXb during 1 horizontal period. In addition, data voltages Vd having opposite polarity to that of the previous dada voltages Vd are applied during a period of predetermined time TC, thereby precharging.

During one frame, data voltages Vd corresponding to the normal image data Na are applied to all sub-pixels PXa, and data voltages Vd corresponding to the normal image data Nb and the impulse data I are applied to all sub-pixels PXb once for each, thereby displaying normal images and impulse images for one frame.

As illustrated in FIG. 12, pixel voltages Vp having positive-polarity and negative-polarity are alternately charged in the sub-pixels PXa and PXb every three rows of pixels, and the charge ratio of pixel voltage Vp is increased because, when the polarity is reversed, data lines DL are precharged with a predetermined data voltage having the same polarity as the next during a period of the predetermined time TC. Numerous characteristics of the LCD illustrated in FIG. 10 and FIG. 11 may be applied to the LCD illustrated in FIG. 12.

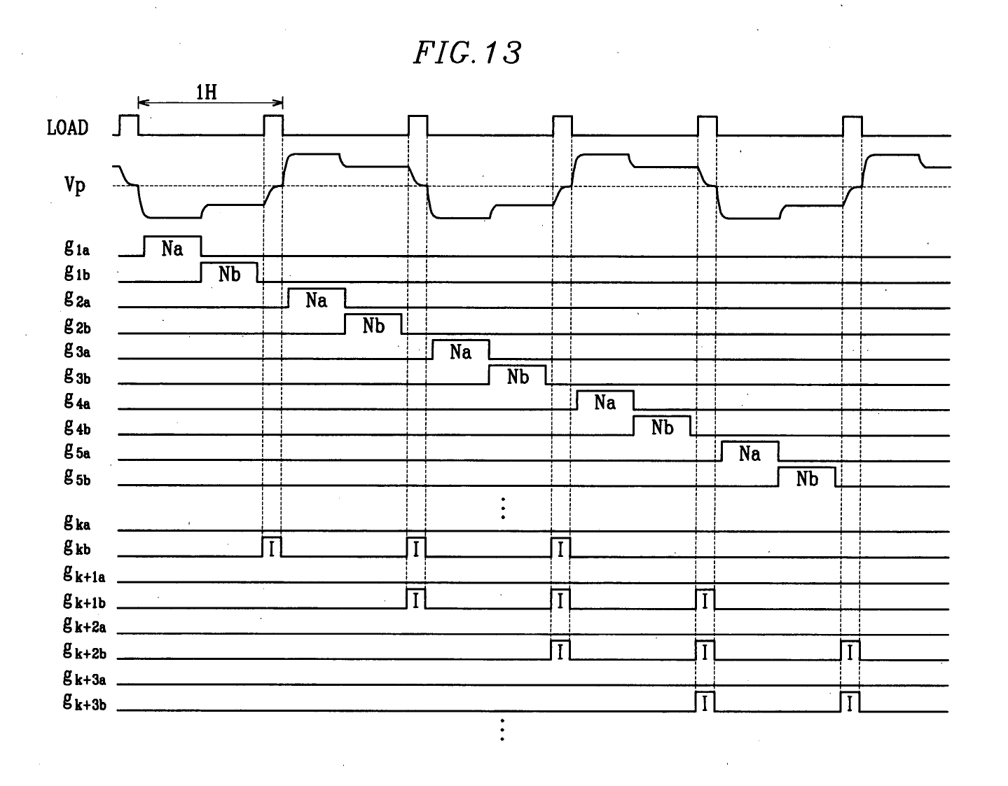

Another driving method for displaying impulse images in an LCD including the pixel illustrated in FIG. 9 will be described in detail with reference to FIG. 13. FIG. 13 is a timing diagram illustrating other examples of driving signals of an LCD according to other embodiments of the present invention.

Signal controller 600 converts the input image signals R, G, and B into normal image data for the sub-pixels PXa and PXb, but it does not generate impulse data separately. Gray voltage generator 800 generates separate sets of gray voltages for the two sub-pixels PXa and PXb respectively, which are alternately supplied to data driver 500 or alternately selected by data driver 500. Data driver 500, as already described with reference to FIGS. 5 to 7, has the function of charge sharing that connects all input terminals of data driver 500 inside during a certain period of time.

When the polarity of half of the data voltages from data driver 500 is positive and the polarity of the other half is negative, half of the whole data lines DL are charged with data voltages having positive-polarity and the other half are charged with data voltages having negative-polarity.

Therefore, when data driver 5.00 connects all output terminals, the charges in data lines DL are rearranged so that the output terminals of data driver 500 are applied with a charge sharing voltage I that is in the middle between the positive-polarity and the negative-polarity voltages, which is approximately on a level of the common voltage Vcom.

Gate driver 400 applies a gate-on voltage Von to the sub-pixels PXb in a predetermined row such that the charge sharing voltage I is applied to the sub-pixels PXb in a predetermined row. Charge sharing voltage I is used as an impulse data voltage.

Referring to FIG. 13, the period of 1H is divided into two parts of a data voltage output period when the load signal LOAD has a low level and a charge sharing period when the load signal LOAD has a high level.

Data driver 500 receives normal image data for a row of pixels from signal controller 600, and in the first half of the data voltage output period, selects gray voltages corresponding to the normal image data out of the set of gray voltages for the sub-pixels PXa generated by the gray voltage generator 800, which are applied to data lines DL as data voltages Na.

Gate driver 400 applies a gate-on voltage Von to a gate line GLa connected to the sub-pixels PXa, thereby applying data voltages Na applied to data lines DL to the corresponding sub-pixels PXa.

Then, in the second half of the data voltage output period, the set of gray voltages for the sub-pixels PXb are supplied to data driver 500 by the gray voltage generator 800 or selected by data driver 500, thereby applying data voltages Nb for the sub-pixels PXb to data lines DL.

Again, gate driver 400 applies a gate-on voltage Von to gateline GLb connected to the sub-pixels PXb, thereby applying data voltages Nb applied to data lines DL to the corresponding sub-pixels PXb.

A charge sharing period starts when the load signal LOAD has a high level, and data driver 500 shares charges of the whole data lines DL, and as a result, the charge sharing voltage I is applied to data lines DL.

At the same time, gate driver 400 applies a gate-on voltage Von to a gate line GLb connected to the sub-pixels PXb in a predetermined row of pixels (for example, the k-th row of pixels), thereby applying the charge sharing voltage I to the corresponding sub-pixels PXb. By repeating this procedure eavh unit of the horizontal period, all sub-pixels PXa and PXb display normal images and impulse images according to the charge sharing voltage I during one frame.

As illustrated in FIG. 13, the charge sharing voltage I may be applied to the sub-pixels PXb in a row of pixels during a plurality of horizontal periods, or the charge sharing voltage I may be applied to the sub-pixels PXb in a plurality of rows of pixels at the same time.

Charge sharing voltage I can be applied to the sub-pixels PXb sufficiently even when the charge sharing period is short. In the data voltage output period, the lengths of the periods when data voltages Na and Nb for the sub-pixels PXa and PXb are applied respectively may be different from each other.

According to the present embodiment, as mentioned above, since data driver 500 supplies voltages for impulse images through charge sharing at the output terminals, instead of generating impulse data separately, the operation of signal controller 600 and data driver 500 are simple, and it is unnecessary for the gray voltage generator 800 to generate an additional set of gray voltages.

In addition, when the polarity of the data voltages is subject to row inversion or dot inversion, the charge ratio of the pixel voltages can be increased since data lines DL are charged sufficiently to the level of the common voltage Vcom. Numerous characteristics of the LCD illustrated in FIG. 10 and FIG. 11 may be applied to the LCD illustrated in FIG. 13.

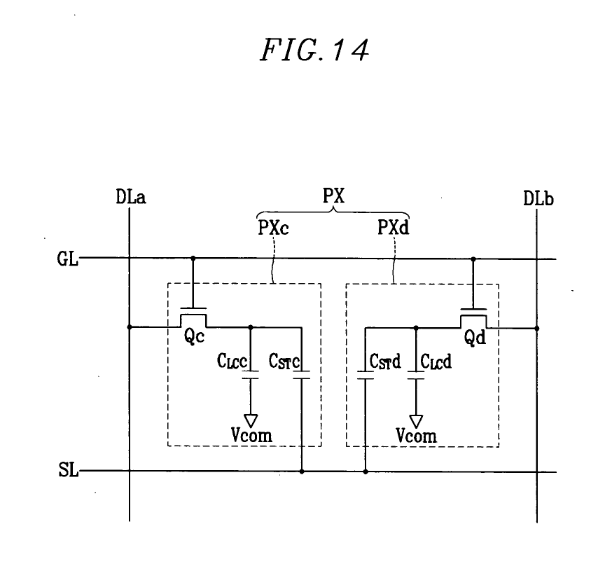

An LCD according to another embodiment of the present invention, wherein the two sub-pixels illustrated in FIG. 8 are applied with different data voltages through different data lines at the same time, will be described in detail with reference to FIG. 14. FIG. 14 is an equivalent circuit diagram of a pixel of an LCD according to another embodiment of the present invention.

Referring to FIG. 14, an LCD according to another embodiment of the present invention has signal lines including a plurality of gate lines GL, a plurality of pairs of data lines DLa and DLb, and a plurality of storage electrode lines SL and a plurality of pixels PX connected to the signal lines. Each pixel PX includes a pair of sub-pixels PXc and PXd, and each sub-pixel PXc/PXd includes a switching element Qc/Qd that is connected to the corresponding gate line GL and data line DLa/DLb respectively, an LC capacitor C_{LC}c/C_{LC}d that is connected to the switching element Qc/Qd, and a storage capacitor C_{ST}c/C_{ST}d that is connected to the switching element Qc/Qd and the storage electrode line SL.

Each switching element Qc/Qd, including a TFT, is a three-terminal element provided on the lower panel 100 and has a control terminal connected to a gate line GL, an input terminal connected to a data line DLa/DLb, and an output terminal connected to an LC capacitor C_{LC}c/C_{LC}d and a storage capacitor C_{ST}c/C_{ST}d. The detailed description of the LC capacitors C_{LC}c and C_{LC}d and the storage capacitors C_{ST}c and C_{ST}d, which were described above in the previous embodiment, will be omitted.

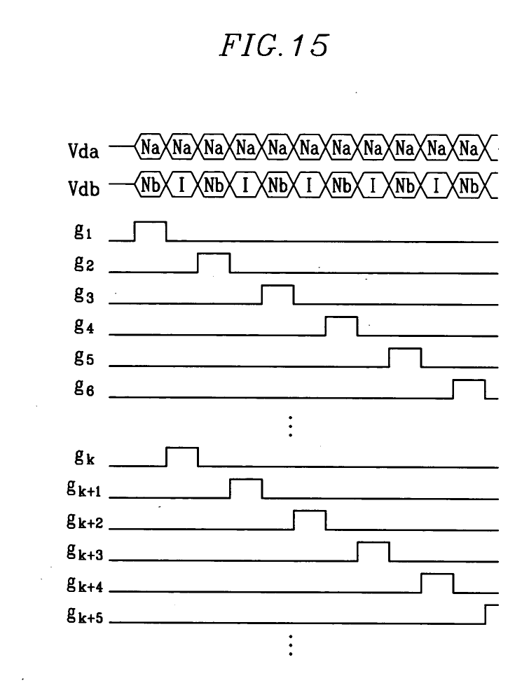

The operation of the above-described LCD will be described in detail with reference to FIG. 15 which is a timing diagram illustrating driving signals of an LCD including the pixel illustrated in FIG. 14.

In the LCD including the pixel illustrated in FIG. 14, signal controller 600 supplied with input image signals R, G, and B for a row of pixels converts them into output image signals DAT including normal image data Na for the sub-pixels PXc and normal image data Nb for the sub-pixels PXd, or it converts them into output image signals DAT including normal image data Na for the sub-pixels PXc and impulse data I for the sub-pixels PXd, which are transmitted to data driver 500.

Data driver 500 receives output image signals DAT for a row of pixels, converts the output image signals DAT into analog data voltages Vda and Vdb by selecting gray voltages corresponding to the respective output image signals DAT, and applies the analog data voltages Vda and Vdb to the corresponding data lines DLa and DLb, respectively.

When the gray voltage generator 800 generates one set of gray voltages, the normal image data Na and Nb may be generated to be different from each other, thereby applying different voltages to respective sub-pixels PXc and PXd. It is preferable to compensate the image signals or generate sets of gray voltages such that the merged gamma curve of the two sub-pixels PXc and PXd is close to the frontal reference gamma curve.

For example, the frontal merged gamma curve is made to accord with the frontal reference gamma curve that is determined to be the most appropriate for the liquid crystal panel assembly, and the lateral merged gamma curve is made to be most similar to the frontal reference gamma curve.

As illustrated in FIG. 15, data driver 500 applies data voltages Vda and Vdb corresponding respectively to the normal image data Na and Nb for the respective sub-pixels PXc and PXd in the first row of pixels to the corresponding data lines DLa and DLb, respectively.

Gate driver 400 applies gatesignal g₁ to gateline GL connected to the sub-pixels PXc and PXd in the first row of pixels, thereby turning on the switching elements Qc and Qd connected to gateline GL at the same time.

Data voltages Vda and Vdb applied respectively to data lines DLa and DLb are applied to the corresponding sub-pixels PXc and PXd through the turned-on switching elements Qc and Qd, respectively.

Dta driver 500 applies data voltages Vda and Vdb corresponding respectively to the normal image data Na and the impulse data I for the respective sub-pixels PXc and PXd in the k-th row of pixels to the corresponding data lines DLa and DLb, respectively.

Gate driver 400 applies gatesignal gₖ to gateline GL connected to the sub-pixels PXc and PXd in the k-th row of pixels, thereby turning on the switching elements Qc and Qd connected to gateline GL at the same time.

Data voltages Vda and Vdb applied respectively to data lines DLa and DLb are applied to the corresponding sub-pixels PXc and PXd through the turned-on switching elements Qc and Qd, respectively. In this way, data voltages Vda and Vdb corresponding to the normal image data Na and Nb are applied to the sub-pixels PXc and PXd in a row of pixels respectively, and data voltages Vda and Vdb corresponding respectively to the normal image data Na and the impulse data I are applied to the sub-pixels PXc and PXd in one other row of pixels respectively, alternately every 1 horizontal period.

During one frame, data voltages Vda corresponding to the normal image data Na are applied to all sub-pixels PXc, and data voltages Vdb corresponding to the normal image data Nb and the impulse data I are applied to all sub-pixels PXd once for each, thereby displaying normal images and impulse images for one frame. Numerous characteristics of the LCD illustrated in FIG. 9 to FIG. 11 may be applied to the LCD illustrated in FIG. 14 and FIG. 15.

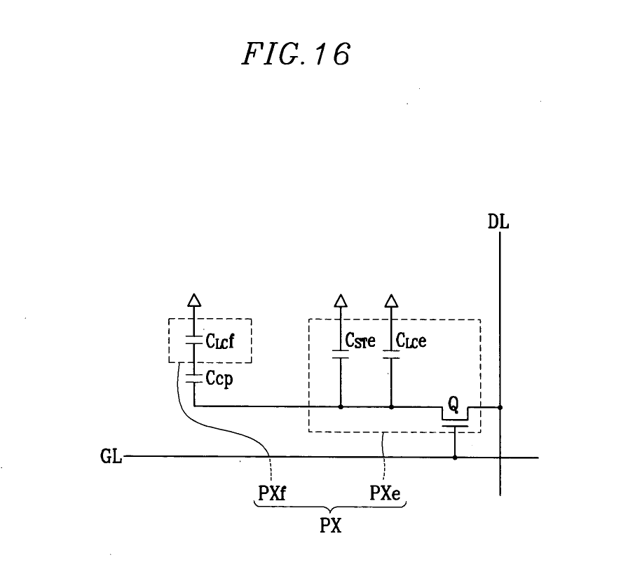

An LCD according to another embodiment of the present invention, wherein only one sub-pixel of the two sub-pixels illustrated in FIG. 8 is applied with a data voltage through a switching element and the other pixel is capacitively coupled, will be described in detail with reference to FIG. 16 which is an equivalent circuit diagram of a pixel of an LCD according to another embodiment of the present invention.

Referring to FIG. 16, an LCD according to another embodiment of the present invention has signal lines including a plurality of gate lines GL and a plurality of data lines DL, and a plurality of pixels PX connected to the signal lines. Each pixel PX includes a pair of a first sub-pixel PXe and a second sub-pixel PXf and a coupling capacitor Ccp connected between the two sub-pixels PXe and PXf.

The first sub-pixel PXe includes a switching element Q that is connected to the corresponding gate line GL and data line DL, and a first LC capacitor C_{LC}e and a storage capacitor CST that are connected to the switching element Q, and the second sub-pixel PXf includes a second LC capacitor C_{LC}f connected to the coupling capacitor Ccp.

Switching element Q, including a TFT, is a three-terminal element provided on the lower panel 100, and it has a control terminal connected to a gate line GL, an input terminal connected to a data line DL, and an output terminal connected to an LC capacitor C_{LC}e, a storage capacitor C_{ST}e, and a coupling capacitor Ccp.

Switching element Q applies data voltages from a data line DL to the first LC capacitor C_{LC}e and the coupling capacitor Ccp in response to a gate signal from a gate line, and the coupling capacitor Ccp transmits the data voltage having a modified magnitude to the second LC capacitor C_{LC}f.

If storage capacitor C_{ST}e is supplied with the common voltage Vcom and each of the capacitors C_{LC}e, C_{ST}e, C_{LC}f, and Ccp and the capacitances thereof are denoted as the same reference characters, the relation between the voltage Ve charged across the first LC capacitor and the voltage Vf charged across the second LC capacitor C_{LC}f is given by:
Vf=Ve×[Ccp/(Ccp+C_{LC}f)]

Since the term Ccp/(Ccp+C_{LC}f) is smaller than one, the voltage Vf charged across the second LC capacitor C_{LC}f is always smaller than the voltage Ve charged across the first LC capacitor C_{LC}e. This inequality of voltages may be also true for a case that the voltage supplied to the storage capacitor C_{ST}e is not equal to the common voltage Vcom.

The appropriate ratio of the voltage Ve of the first LC capacitor C_{LC}e and the voltage Vf of the second LC capacitor C_{LC}f can be adjusted by varying the capacitance of the coupling capacitor Ccp.

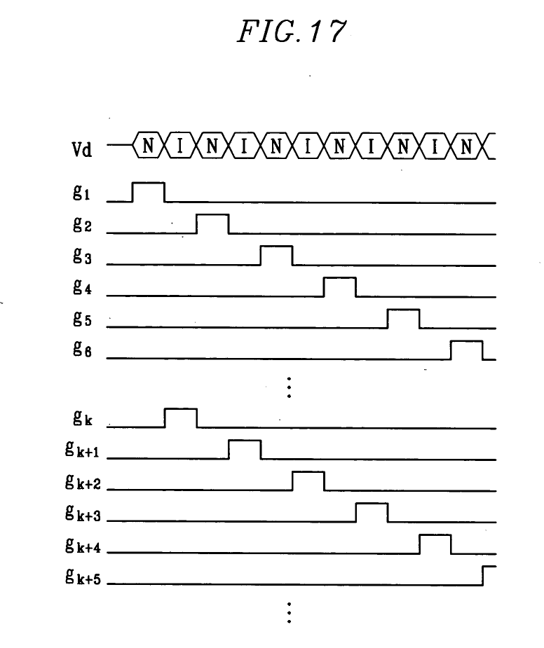

The operation of the above-described LCD will be described in detail with reference to FIG. 17 which is a timing diagram illustrating driving signals of an LCD including the pixel illustrated in FIG. 16.

In the LCD including the pixel illustrated in FIG. 16, signal controller 600 supplied with input image signals R, G, and B for a row of pixels converts them into output image signals DAT including normal image data N or impulse data I, which are transmitted to data driver 500.

Data driver 500 receives output image signals DAT for a row of pixels, converts the output image signals DAT into analog data voltages Vd by selecting gray voltages corresponding to the respective output image signals DAT, and applies the analog data voltages Vd to the corresponding data lines DL. As illustrated in FIG. 17, data driver 500 applies data voltages Vd corresponding to the normal image data N for the first row of pixels to the corresponding data lines DL.

Gate driver 400 applies gatesignal g₁ to gateline GL in the first row of pixels, thereby turning on the switching elements Q connected to gateline GL. Data voltages Vd applied to data lines DL are applied to the corresponding sub-pixels PXe through the turned-on switching elements Q.

Data driver 500 applies data voltages Vd corresponding to the impulse data I for the k-th row of pixels to the corresponding data lines DL. Gate driver 400 applies gatesignal gₖ to gateline GL in the k-th row of pixels, thereby turning on the switching elements Q connected to gateline GL. Data voltages Vd applied to data lines DL are applied to the corresponding sub-pixels PXe through the turned-on switching elements Q. In this way, data voltages Vd corresponding to the normal image data N are applied to the sub-pixels PXe in a row of pixels, and data voltages Vd corresponding to the impulse data I are applied to the sub-pixels PXe in one other row of pixels, alternately every one horizontal period.

During one frame, data voltages Vd corresponding to the normal image data N and the impulse data I are applied to all sub-pixels PXe once for each, thereby displaying normal images and impulse images for one frame. Numerous characteristics of the LCD illustrated in FIG. 14 and FIG. 15 may be applied to the LCD illustrated in FIG. 16 and FIG. 17.

As mentioned above, according to the present invention, the charge ratio of the pixel voltages can be increased since the driving time for displaying impulse images can be relatively reduced by displaying impulse images in a plurality of rows of pixels at the same time, as a result, flickering of the screen due to a low charge ratio can be minimized.

Also, luminance decrease can be minimized as well as blurring prevented by displaying an impulse image in one sub-pixel while a normal image is displayed in the other sub-pixel.

Although preferred embodiments of the present invention have been described in detail hereinabove, it should be clearly understood that many variations and/or modifications of the basic inventive concepts herein taught will be apparent to those skilled in the art, will still fall within the spirit and scope of the present invention.

What is claimed is:

1. A liquid crystal display comprising:
a plurality of gate lines transmitting a gate-on voltage;
a plurality of data lines transmitting first and second normal image data voltages and an impulse data voltage;
a plurality of pixels connected to the gate lines and the data lines, each of the pixels including first and second sub-pixel electrodes;
a gate driver connected to the gate lines and applying the gate-on voltage to the gate lines; and
a data driver connected to the data lines and applying the first and second normal image data voltages and the impulse data voltage to the data lines,
wherein the first and second normal image data voltages applied to the first sub-pixel electrode and the second sub-pixel electrode respectively are different from each other and are obtained from one image information, and
the impulse data voltage is applied to any one of the first and second sub-pixel electrodes.

2. The liquid crystal display of claim 1, wherein the first normal image data voltages are greater than the second normal image data voltages, and the area of the first sub-pixel electrode is smaller than the area of the second sub-pixel electrode.

3. The liquid crystal display of claim 2, wherein the impulse data voltage is applied to the second sub-pixel electrode.

4. The liquid crystal display of claim 1, wherein the impulse data voltage is lower than the first and second normal image data voltages.

5. The liquid crystal display of claim 4, wherein the impulse data voltage is any one among the lowest gray voltage, a black gray voltage, and a gray voltage for luminance in a predetermined range.

6. The liquid crystal display of claim 1, further comprising a signal controller that receives M bundles of image information, converts them into respective M bundles of first and second normal image data, generates a bundle of impulse data, and then transmits the first and second normal image data and the impulse data to the data driver (where M is a natural number).

7. The liquid crystal display of claim 6, wherein the first normal image data are greater than the second normal image data, and the impulse data are smaller than the second normal image data.

8. The liquid crystal display of claim 1, wherein a first set of gray voltages and a second set of gray voltages that are different from each other are generated, and the first and second normal image data voltages are selected from the first and second sets of gray voltages respectively and applied to the first and second sub-pixel electrodes, respectively.

9. The liquid crystal display of claim 1, wherein first and second switching elements connected to the first and second sub-pixel electrodes respectively are further included, and
the gate lines include first and second gate lines that are connected to the first and second switching elements, respectively.

10. The liquid crystal display of claim 9, wherein the impulse data voltage is applied to the second sub-pixel electrodes in a plurality of rows of pixels at the same time.

11. The liquid crystal display of claim 9, wherein the first and second normal image data voltages are alternately and sequentially applied to the first and second sub-pixel electrodes in a plurality of rows of pixels, respectively.

12. The liquid crystal display of claim 9, wherein the first and second normal image data voltages for the first M rows of pixels are alternately and sequentially applied to the first and second sub-pixel electrodes in the first M rows of pixels, and then the impulse data voltage is applied to the second sub-pixel electrodes in the second M rows of pixels at the same time (where M is a natural number).

13. The liquid crystal display of claim 12, wherein the impulse data voltage is applied to the second sub-pixel electrodes in the second M rows of pixels, and then a predetermined precharge voltage having polarity that is opposite to the polarity of the first and second normal image data voltages applied to the first and second sub-pixel electrodes in the first M rows of pixels is applied to the data lines.

14. The liquid crystal display of claim 9, wherein the data driver connects a plurality of output terminals and the gate driver applies the gate-on voltage to the second gate line.

15. The liquid crystal display of claim 14, wherein the gate driver applies the gate-on voltage to the second gate line a plurality of times during a plurality of horizontal periods.

16. The liquid crystal display of claim 14, wherein the gate driver applies the gate-on voltage to the second gate lines in a plurality of rows of pixels at the same time.

17. The liquid crystal display of claim 1, wherein first and second switching elements connected to the first and second sub-pixel electrodes respectively are further included, and
the data lines include first and second data lines that are connected to the first and second switching elements, respectively.

18. The liquid crystal display of claim 17, wherein the first and second normal image data voltages for a first row of pixels are applied to the first and second sub-pixel electrodes in the first row of pixels respectively, and then the first normal image data voltages and the impulse data voltage for a second row of pixels are applied to the first and second sub-pixel electrodes in the second row of pixels respectively.

19. A method of driving a liquid crystal display including a plurality of pixels that include first and second sub-pixel electrodes, the method comprising:
applying first and second normal image data voltages to the first and second sub-pixel electrodes respectively; and
applying an impulse data voltage to one of the first and second sub-pixel electrodes,
wherein the first and second normal image data voltages are different from each other and are obtained from one image information.

20. The method of driving a liquid crystal display of claim 19, wherein the first normal image data voltages are greater than the second normal image data voltages, and the area of the first sub-pixel electrode is smaller than the area of the second sub-pixel electrode.

21. The method of driving a liquid crystal display of claim 20, wherein the impulse data voltage is applied to the second sub-pixel electrode.

22. The method of driving a liquid crystal display of claim 21, wherein the impulse data voltage is applied to the second sub-pixel electrodes in a plurality of rows of pixels at the same time.

23. The method of driving a liquid crystal display of claim 20, wherein the impulse data voltage is any one among the lowest gray voltage, a black gray voltage, and a gray voltage for luminance in a predetermined range.

24. The method of driving a liquid crystal display of claim 19, further comprising:
converting M bundles of image information received into respective M bundles of first and second normal image data and generating a bundle of impulse data; and
converting the first and second normal image data and the impulse data into the first and second normal image data voltages and the impulse data voltage, respectively (where M is a natural number).

25. The method of driving a liquid crystal display of claim 24, wherein the first normal image data are greater than the second normal image data, and the impulse data are smaller than the second normal image data.

26. The method of driving a liquid crystal display of claim 19, wherein the application of the first and second normal image data voltages comprises:
generating first and second sets of gray voltages that are different from each other; and
selecting the first and second normal image data voltages from the first and second sets of gray voltages.

27. The method of driving a liquid crystal display of claim 19, wherein the application of the first and second normal image data voltages comprises a step of applying the first and second normal image data voltages for the first M rows of pixels to the first and second sub-pixel electrodes in the first M rows of pixels alternately and sequentially, respectively, and
the application of the impulse data voltage comprises a step of applying the impulse data voltage to the second sub-pixel electrodes in the second M rows of pixels at the same time (where M is a natural number).

28. The method of driving a liquid crystal display of claim 19, wherein the application of the first and second normal image data voltages comprises a step of applying the first and second normal image data voltages for a first row of pixels to the first and second sub-pixel electrodes in the first row of pixels respectively, and
the application of the impulse data voltage comprises a step of applying the first normal image data voltages and the impulse data voltage for a second row of pixels to the first and second sub-pixel electrodes in the second row of pixels respectively.
